(19) United States
(12) Patent Application Publication
(10) Pub. No.: US 2026/0252216 A1
(43) Pub. Date: Aug. 27, 2026

(54) METHOD AND APPARATUS FOR VIEWING INTERFACE CONTENT, DEVICE, MEDIUM AND PROGRAM PRODUCT

(71) Applicant: Beijing Zitiao Network Technology Co., Ltd., Beijing (CN)

(72) Inventor: Shengfan HE, Culver City, CA (US)

(21) Appl. No.: 19/461,526

(22) Filed: Jan. 27, 2026

(30) Foreign Application Priority Data
Jan. 27, 2025 (WO) PCT/CN2025/075555

(51) Int. Cl. G06F 3/0484; G06F 3/04812; G06F 3/0487; G06F 9/451

(52) U.S. Cl. CPC G06F 3/0484; G06F 3/04812; G06F 3/0487; G06F 9/451

(57) ABSTRACT

Embodiments of the present disclosure provide a method and apparatus for viewing interface content, a device, a medium and a program product. The method includes displaying first content and a first recommendation strategy information set for recommending the first content on a user interface. The method further includes in response to receiving, in a display area of the first content, a swiping operation for the first content, obtaining second content and a second recommendation strategy information set for recommending the second content. The method further includes in response to the swiping operation being completed, displaying the second content and the second recommendation strategy information set on the user interface.

### CROSS-REFERENCE TO RELATED APPLICATION(S)

This application claims priority to International Patent Application No. PCT/CN2025/075555 filed in January 27, 2025, the disclosure of which is incorporated herein by reference in its entirety.

### FIELD

Embodiments of the present disclosure generally relate to the field of human-computer interaction, and more specifically, to method and apparatus for viewing interface content, device, medium and program product.

### BACKGROUND

At present, the development of human-computer interaction is more and more rapid. In the fields of Internet, Internet of Things, and etc., human-computer interaction is always an indispensable technology, and the development of software applications also needs to consider user’s interactive experience in the process of use. Therefore, human-computer interaction has become the subject of in-depth research by many developers. Developers are also committed to constantly improving the efficiency of using application by user through enhancing the human-computer interaction.

With the continuous development of human-computer interaction, people may obtain any appropriate information through interactions with display interfaces. For example, if users click link information in an interface, they may obtain specific information related to the link and display the information on the user interface. As the development of webpage browser technology, text information and/or video/audio information can be quickly obtained from the network in the browser interface through user interactions. Hence, interaction with display interface enable users to view more and more information.

### SUMMARY

Embodiments of the present disclosure provide a method and apparatus for viewing interface content, a device, a medium and a program product.

In accordance with a first aspect of the present disclosure, a method for viewing interface content is provided. The method includes displaying first content and a first recommendation strategy information set for recommending the first content on a user interface. The method further includes in response to receiving, in a display area of the first content, a swiping operation for the first content, obtaining second content and a second recommendation strategy information set for recommending the second content. The method further includes in response to the swiping operation being completed, displaying the second content and the second recommendation strategy information set on the user interface.

In accordance with a second aspect of the present disclosure, an apparatus for viewing interface content is provided. The apparatus includes a first content and information set display module, configured to display first content and a first recommendation strategy information set for recommending the first content on a user interface; a content and information set obtaining module, configured to, in response to receiving, in a display area of the first content, a swiping operation for the first content, obtain second content and a second recommendation strategy information set for recommending the second content; and a second content and information set display module, configured to, in response to the swiping operation being completed, display the second content and the second recommendation strategy information set on the user interface.

In accordance with a third aspect of the present disclosure, an electronic device is provided, the electronic device includes at least one processor; and a storage apparatus, configured to store at least one program, the at least one program, when executed by the at least one processor, causes the at least one processor to implement the method according to the first aspect of the present disclosure.

In accordance with a fourth aspect of the present disclosure, a computer-readable storage medium is provided, the computer-readable storage medium storing a computer program thereon, the computer program, when executed by a processor, implements the method according to the first aspect of the present disclosure.

In accordance with a fifth aspect of the present disclosure, a computer program product is provided. The computer program product includes a computer program, the computer program, when executed by a processor, implements the method according to the first aspect of the present disclosure.

It should be appreciated that the content described in this Summary are not intended to define key or essential features of the embodiments of the present disclosure, or limit the scope of the present disclosure. Other features of the present disclosure will be understood more easily through the following description.

### BRIEF DESCRIPTION OF THE DRAWINGS

Through the more detailed description of the exemplary embodiments of the present disclosure with reference to the accompanying drawings, the above and other objectives, features, and advantages of the present disclosure will become more apparent. In the exemplary embodiments of the present disclosure, the same reference sign usually indicates the same component.

FIG. 1 illustrates a schematic diagram of an example environment in which the device and/or method according to some embodiments of the present disclosure may be implemented;

FIG. 2 illustrates a schematic diagram of an example method for viewing interface content according to some embodiments of the present disclosure;

FIG. 3 illustrates a schematic diagram of an example of the vertical arrangement of interface content according to some embodiments of the present disclosure;

FIG. 4 illustrates a schematic diagram of an example of a swiping operation for viewing interface content according to some embodiments of the present disclosure;

FIG. 5 illustrates a schematic diagram of an example of a tile arrangement of interface content according to some embodiments of the present disclosure;

FIG. 6 illustrates a schematic diagram of an example of the recommendation strategy information set for viewing interface content according to some embodiments of the present disclosure;

FIG. 7 illustrates a schematic diagram of an example of synchronous scroll for viewing interface content according to some embodiments of the present disclosure;

FIG. 8 illustrates a schematic block diagram of an apparatus for viewing interface content according to some embodiments of the present disclosure;

FIG. 9 illustrates a schematic block diagram of an example device adapted to implement a plurality of embodiments of the present disclosure.

In each drawing, same or corresponding reference sign indicates the same or corresponding component.

### DETAILED DESCRIPTION OF EMBODIMENTS

It is to be understood that data involved in the technical solutions of the present disclosure (including but not limited to data per se, and acquisition or use of the data), should follow requirements of corresponding laws, regulations and rules.

It is to be appreciated that prior to the use of the technical solutions disclosed by various embodiments of the present disclosure, type, usage scope and application scenario of personal information involved in the present disclosure are made known to users through suitable ways in accordance with the relevant laws and regulations, and obtain user authorization.

For example, in response to receiving an active request from the users, a prompt message is sent to the users to clearly inform them that the operation requested to be executed needs to obtain and use their personal information. Accordingly, the users may voluntarily select, in accordance with the prompt message, whether to provide their personal information to software or hardware that performs operations of the technical solution, such as electronic device, application program, server or storage medium.

As an optional and non-restrictive implementation, in response to receiving an active request from the users, a prompt message is sent to the users, the prompt message may be present in the form of pop-up window as an example and the prompt message may be displayed in text in the pop-up window. Besides, the pop-up window also may be provided with a select control through which the users may choose to “agree” or “disagree” the provision of personal information to the electronic device.

It should be appreciated that the above procedure for informing the users and obtaining the user authorization is only exemplary and does not restrict the implementations of the present disclosure. Other methods may also be applied to the implementations of the present disclosure as long as they comply with relevant regulations and laws.

Embodiments of the present disclosure will be described below in more details with reference to the drawings. Although the drawings illustrate some embodiments of the present disclosure, it should be appreciated that the present disclosure can be implemented in various manners and should not be limited to the embodiments explained herein. On the contrary, the embodiments are provided for a more thorough and complete understanding of the present disclosure. It is to be understood that the drawings and the embodiments of the present disclosure are provided merely for the exemplary purpose, rather than restricting the protection scope of the present disclosure.

In the description of the embodiments of the present disclosure, the term “includes” and its variants are to be read as open-ended terms that mean “includes, but is not limited to.” The term “based on” is to be read as “based at least in part on.” The term “one embodiment” or “this embodiment” is to be read as “at least one embodiment.” The terms “first”, “second” and so on can refer to same or different objects. The following text also may include other explicit and implicit definitions.

There are still many problems to be solved in the process of viewing interface content. Usually, users can only browse content, e.g., video content created by users. This content may be broadcast on a network and viewed by other users on the network. In the process of pushing such content, usually, some recommendation strategies needed to be utilized to push the content to target users who may view the content. However, during the process, users and technicians could not promptly obtain usage of the recommendation strategies, so as to fail to accurately analyze validity of algorithms related to recommendation strategies or improve the recommendation strategies.

To at least solve the above and other potential problems, embodiments of the present disclosure provide a method for viewing interface content. In this method, a computing device may display first content and a first recommendation strategy information set for recommending the first content on a user interface. Then, the computing device receives, in a display area of the first content, a swiping operation for the first content and obtains second content and a second recommendation strategy information set for recommending the second content. In the end, after the swiping operation is completed, the computing device displays the second content and the second recommendation strategy information se on the user interface t. According to this method, display of content and related recommendation strategy information is adjusted using the swiping operation, such that users may quickly obtain the technical information related to the recommendation of the generated content, the analytical efficiency for determining the recommendation strategy is improved and the user experience is enhanced.

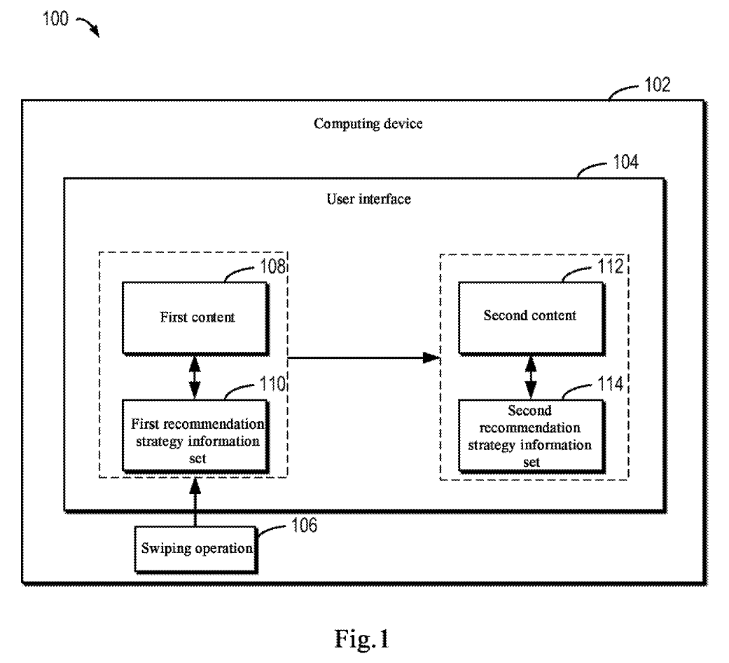

Embodiments of the present disclosure are to be described in details below with reference to the drawings. FIG. 1 illustrates an example environment in which the device and/or method of the embodiments of the present disclosure may be implemented. In the environment 100, the computing device 102 may display first content 108 and a first recommendation strategy information set 110 for recommending the first content on the user interface 104. Then, the computing device 102 may obtain second content 112 and a second recommendation strategy information set 114 for recommending the second content 112 after receiving, in the display area of the first content 108, the swiping operation 106 for the first content 108. After the swiping operation 106 is completed, the computing device 102 may display the second content 112 and the second recommendation strategy information set 114 on the user interface 104. To facilitate the description, the above swiping operation 106 is also referred to as a first swiping operation.

In some embodiments, the content displayed in the user interface may be content displayed in a target application running on a terminal device. The content is provided by one user and may be watched by other users through the target application. For example, the content may be video content. Additionally, the content displayed in the user interface is similar to that displayed in the target application, and for example may include corresponding comment and like information etc. In one example, the content also may be images provided by one user in the application and watched by other users. In addition, the user interface may be a browser interface or any suitable application interfaces. The above examples are provided merely for describing the present disclosure, rather than restricting it.

Examples of the computing device 102 include, but not limited to, personal computer, server computer, hand-held or laptop device, mobile device (e.g., mobile phone, Personal Digital Assistant (PDA), and media player etc.), multi-processor system, consumer electronic product, minicomputer, large-scale computer, and a distributed computing environment including any of the above systems or devices.

As shown in FIG. 1, when the content and the corresponding recommendation strategy information set are displayed on the user interface, the content and the corresponding recommendation strategy information set may be displayed in a vertical arrangement layout in a presentation area of the content and the corresponding recommendation strategy information set. In the vertical arrangement layout, the presentation area is divided into two sections, one section is used to display the content while the other section is used to display the recommendation strategy information set. For example, the left section is used to display the content and the right section is used to display the recommendation strategy information set. Accordingly, multiple content and its corresponding recommendation strategy information sets are displayed in a vertical arrangement on the user interface. Hence, in the vertical arrangement layout, the first content 108 and the first recommendation strategy information set 110 for recommending the first content 108 may be displayed on the user interface 104.

Additionally, to display the first content 108, the computing device 102 may first obtain the first content 108 to be displayed and then pertinently obtain the recommendation strategy information related to the first content 108 at different recommendation phases in accordance with the identity of the first content 108. Afterwards, the first recommendation strategy information set is generated from the obtained recommendation strategy information and displayed in the presentation area of the user interface 104.

The user may move the cursor into the display area of the first content 108. If the computing device receiving a swiping operation 106 for the first content 108 in the display area of the first content 108, e.g., a swiping operation of the cursor, the computing device obtains the second content 112 and the second recommendation strategy information set 114 for recommending the second content 112.

During the execution of swiping operation 106, the first content 108 and/or the first recommendation strategy information set 110 originally displayed in the presentation area would scroll up or scroll down. At the end of the swiping operation, the second content 112 and the second recommendation strategy information set 114 are fully displayed in the presentation area and the scrolling stops.

In some embodiments, the swiping operation is performed via a mouse wheel or a touchpad. In some embodiments, the swiping operation is implemented by moving the position of the cursor.

Through this method, display of content and related recommendation strategy information is adjusted using the swiping operation, such that users may quickly obtain the technical information related to the recommendation of the generated content, the analytical efficiency of the recommendation strategy is improved and user experience is enhanced.

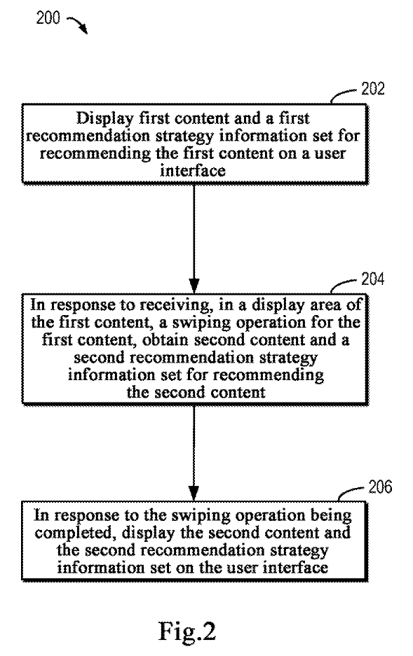

The schematic diagram of the example environment in which the device and/or method according to some embodiments of the present disclosure may be implemented has been described above with reference to FIG. 1. Next, a schematic diagram of an example method for viewing interface content according to some embodiments of the present disclosure is to be depicted below with reference to FIG. 2. The method in FIG. 2 may be executed by the computing device 102 in FIG. 1 and/or any suitable computing devices.

As shown in FIG. 2, in the example method 200, at block 202, the computing device 102 displays first content and a first recommendation strategy information set for recommending the first content on a user interface.

The computing device 102 needs to first determine the specific content of the first content 108 to be displayed and then the first recommendation strategy information set related to the first content 108 is obtained, so as to be displayed in the presentation area 106 of the user interface 104. In some embodiments, the content and the corresponding recommendation strategy information set are stored in association. When the content is obtained, the corresponding recommendation strategy information set is also obtained simultaneously. In some embodiments, the content and the corresponding recommendation strategy information set are stored separately. In such case, user may first obtain the content and then obtain the corresponding recommendation strategy information set in accordance with the identity of the content.

In some embodiments, while obtaining the recommendation strategy information set, the computing device 102 will obtain the recommendation strategy information related to a plurality of recommendation phases of the first content, e.g., the recommendation strategy information for recall phase, merging phase and pre-ranking phase. Then, the computing device 102 generates the first recommendation strategy information set in accordance with the recommendation strategy information related to a plurality of recommendation phases. For example, the information is combined to form the recommendation strategy information set.

Additionally, the presentation area of the user interface is divided into a plurality of display sections for displaying different types of content. For example, the first content 108 and the first recommendation strategy information set 110 and other content and corresponding recommendation strategy information sets are displayed in the presentation interface in a vertical arrangement layout.

Further, the recommendation strategy information in the first recommendation strategy information set 110 corresponding to the first content 108 is displayed in multiple phases. Due to space limitation of the presentation area, the recommendation strategy information displayed in the presentation area is a part of the information in the first recommendation strategy information set 110. In addition, the recommendation strategy information corresponding to at least one phase is displayed in the presentation area.

Then, at block 204, in response to receiving, in a display area of the first content, a swiping operation for the first content, the computing device 102 obtains the second content and the second recommendation strategy information set for recommending the second content.

In the presentation area, the user may choose to process content of different display areas by moving the cursor. For example, the user may move the cursor to the display area of the first content and then perform the swiping operation for the cursor. To facilitate the description, the display area of the first content also may be known as a first display area. Upon the execution of the swiping operation, the first content 108 will be scrolled up or down on the interface and the second content adjacent to the first content will also be displayed simultaneously. Additionally, the content of the first recommendation strategy information set 110 also scrolls accordingly as the first content scrolls.

During the swiping operation, since it is also required to display the second content, the computing device 102 will obtain the second content and the corresponding second recommendation strategy information set upon receiving the swiping operation for the first content.

In the end, at block 206, in response to the swiping operation being completed, the computing device 102 displays the second content and the second recommendation strategy information set on the user interface. After the swiping operation is completed, the second content 112 and the second recommendation strategy information set 114 will be displayed in the presentation area, in replacement of the previously displayed first content 108 and the first recommendation strategy information set 110.

Through this method, display of content and related recommendation strategy information is adjusted using the swiping operation, such that users may quickly obtain the technical information related to the recommendation of the generated content, the analytical efficiency of determining the recommendation strategy is improved and the user experience is enhanced.

Operations on the content in the presentation area of FIG. 1 or FIG. 2 are to be described below with reference to some embodiments. When the content and the corresponding recommendation strategy information set, e.g., first content 108 and first recommendation strategy information set 110, are displayed in a vertical arrangement layout, a tile arrangement control is also displayed in the presentation area. When the tile arrangement control is selected by an operation, the computing device 102 only displays the content in the presentation area. For example, the content is displayed in rows and columns. During this process, the computing device needs to obtain a plurality of pieces of content including the first content 108 and the second content 112 and then displays the plurality of pieces of content including the first content 108 and the second content 112 in tile arrangement on the entire user interface 104.

After a plurality of pieces of content is displayed in the tile arrangement, the user interface 104 also includes a control for the recommendation strategy information, and the control is used to determine whether to display the corresponding recommendation strategy set information. When the control is successfully selected, the computing device 102 selects some pieces of content from a plurality of content displayed in the tile manner. For example, a collection of content is displayed. Besides, the computing device 102 further obtains the corresponding recommendation strategy information set corresponding to the collection of content. Subsequent to obtaining the related information, the collection of content and a corresponding collection of recommendation strategy information sets are displayed in the user interface 104.

When a collection of content is displayed in the presentation area, a collection of recommendation strategy information sets corresponding to the collection of content is also displayed in the presentation area. At this phase, the cursor may move into a second display area of a target recommendation strategy information set corresponding to a target generated content in the collection of content. When receiving a second swiping operation for the target recommendation strategy information set in the second display area, the computing device 102 will display, in a scrolling manner, content of a target recommendation strategy information set in the second display area.

In addition, the control for the recommendation strategy information only exists in the display mode of tile arrangement. Under the display mode of vertical arrangement, the control for the recommendation strategy information is hidden to save page control.

The interface for displaying the collection of content and the corresponding recommendation strategy information sets also may include a synchronous scroll control, the control is used to synchronously scroll the content in the collection of recommendation strategy information sets in the user interface.

After the synchronous scroll control is selected by an operation, if the third swiping operation is received in the second display area, not only the content in the target recommendation strategy information set, but also the content in the recommendation strategy information sets corresponding to other content in the collection of content are scrolled synchronously.

Additionally, after the synchronous scroll control is selected by an operation, the content in each of the collection of the recommendation strategy information sets is automatically scrolled to the same level position synchronously. In such case, it is ensured that every recommendation strategy information set is constantly at the same recommendation phase when the user scrolls to view. Accordingly, it is easy for the user to analyze and compare the recommendation strategies.

In some embodiments, when the cursor moves into the display area of each content, an extension control is displayed in the area. For example, when the cursor moves into a third display area for the target content, the computing device 102 displays the extension control in the third display area. After an operation for the control is received, the content and its corresponding recommendation strategy information set are displayed in a vertical arrangement in the user interface 104.

In some embodiments, the extension control is displayed only when the cursor hovers over the first display area for a predetermined time period. For example, the extension control is displayed when the hover reaches 500 milliseconds.

In some embodiments, the above first swiping operation and second swiping operation are both implemented by a mouse wheel or a touchpad.

In some embodiments, when the cursor hovers over the first display area, the first display area will be visually emphasized. For example, an edge of the first display area is bolded or highlighted or both.

Through this method, display of content and related recommendation strategy information is adjusted using the swiping operation, such that users may quickly obtain the technical information related to the recommendation of the generated content, the analytical efficiency of the recommendation strategy is improved and user experience is enhanced.

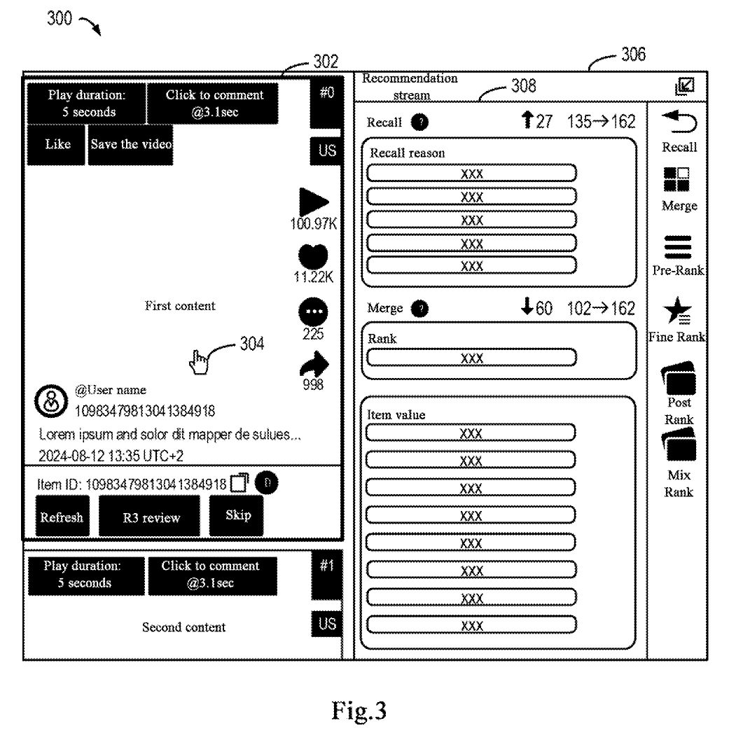

The schematic diagram of the example method for viewing interface content in accordance with some embodiments of the present disclosure has been described above with reference to FIG. 2. Next, a schematic diagram of an example of the vertical arrangement for viewing interface content in accordance with some embodiments of the present disclosure is to be depicted in conjunction with FIG. 3. The example of FIG. 3 may be executed by the computing device 102 shown in FIG. 1 or any suitable devices.

In the example 300 of FIG. 3, the user interface is displayed in a browser. The display is made in a vertical arrangement in the presentation area 306, and the displayed content includes first content 302 and recommendation strategy information 308 for the content 302.

After a selection for the content 302 is received, the first content 302 is displayed in the presentation area 306, the first content 302 is content in the collection of content.

In case that the display of the collection of content 302 has been completed in the presentation area 306, if the cursor 304 hovers over the first content 302, the content will be visually emphasized. In one example, frames of the first content 302 is highlighted. In another example, frames of the first content 302 are bolded. In a further example, frames of the first content 302 are highlighted and bolded.

Moreover, the recommendation strategy information set 308 for the first content is also displayed in the presentation area 306, and the information related to the first content 302, e.g., recall information and merge information of the first content 302 etc., is displayed in the recommendation strategy information set 308. And a set of operable components is also placed in a column to the far right of the presentation area 306. From top to bottom, the set of operable components include Recall component, Merge component, Pre-rank Component, Fine Rank component, Post Rank component and Mix Rank component respectively corresponding to different phases of the recommendation strategy.

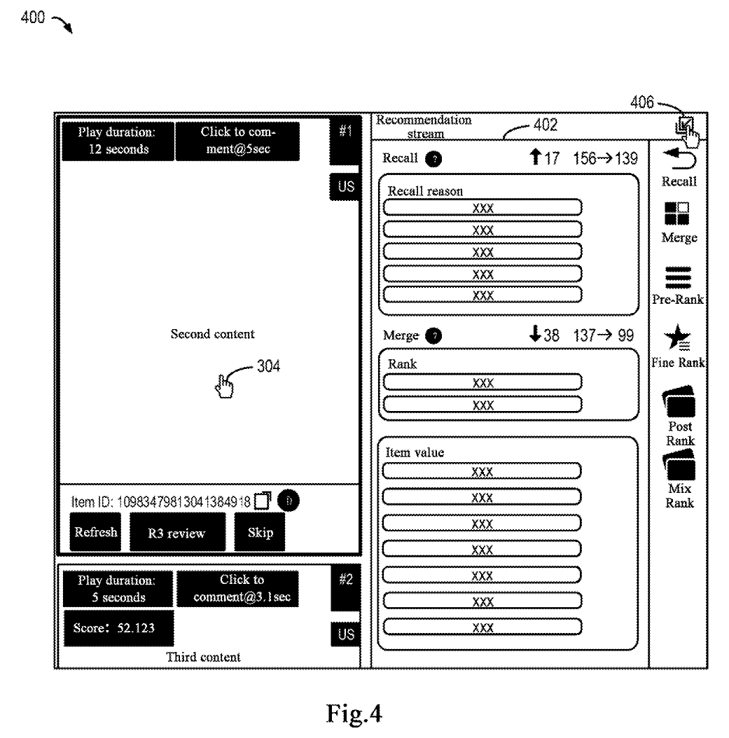

When the cursor moves to hover over the first content 302, the cursor 304 may not need to be moved, the currently displayed first content 302 is switched to the adjacent second content in the presentation area 306 after the swiping operation for the cursor 304 is received. Detailed description is provided below with reference to FIG. 4.

The schematic diagram of the example of the vertical arrangement for viewing interface content in accordance with some embodiments of the present disclosure has been described above with reference to FIG. 3. Next, a schematic diagram of an example of a swiping operation for viewing interface content in accordance with some embodiments of the present disclosure is to be depicted in conjunction with FIG. 4.

In the example 400 of FIG. 4, with reference to the previous example 300, after the swiping operation for the cursor 304 is received, the currently displayed first content 302 is switched to the adjacent second content in the presentation area 306.

It is observed that after the display content in the presentation area 306 is switched to the second content, the original first content 302 is no longer displayed and a part of a third content adjacent to the second content may be displayed below the second content.

Meanwhile, the recommendation strategy information set 308 is automatically switched to a recommendation strategy information set 402 related to the second content. If it is required to switch the display mode of the user interface at this moment, a tile arrangement control 406 is operated to switch the display mode of the user interface from vertical arrangement to tile arrangement.

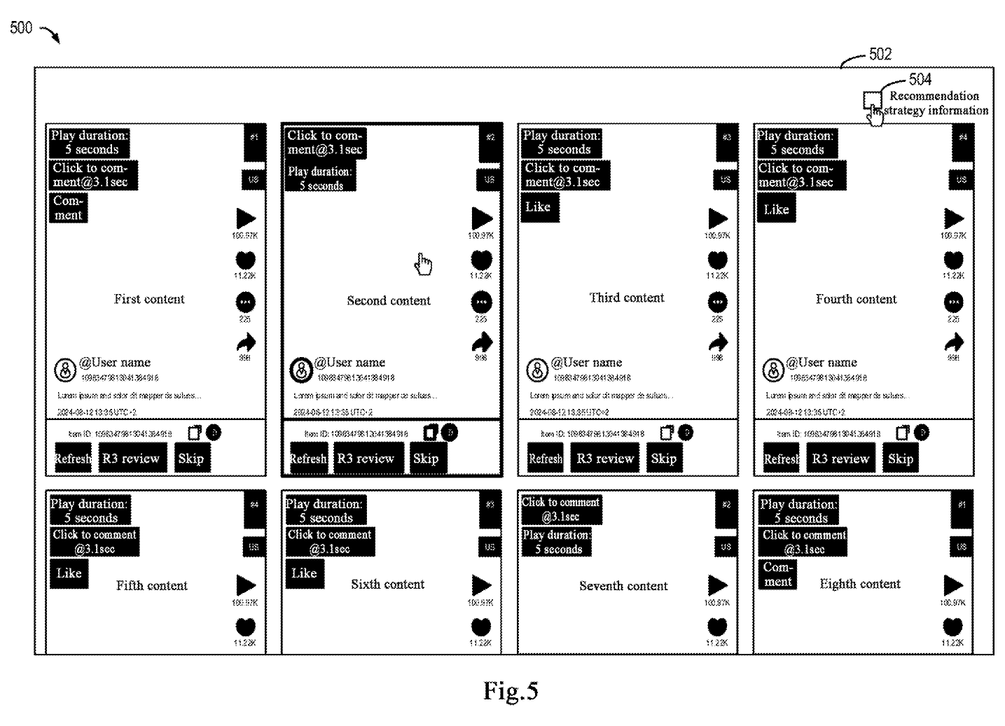

The schematic diagram of the example of the swiping operation for viewing interface content in accordance with some embodiments of the present disclosure has been described above with reference to FIG. 4. Next, a schematic diagram of an example of a tile arrangement for viewing interface content in accordance with some embodiments of the present disclosure is to be depicted in conjunction with FIG. 5.

In the example 500 of FIG. 5, with reference to the previous example 400, after the display mode of the user interface is switched from the vertical arrangement to the tile arrangement by operating the tile arrangement control 502, a plurality of pieces of content will be automatically displayed in sequence in a tile arrangement in the presentation area 502.

In some embodiments, after the display mode is switched to tile arrangement, only the content is displayed by default and the recommendation information is not displayed.

In such case, a recommendation strategy information control 504 appears in the presentation area 502 for selection. When the recommendation strategy information control is selected, a collection of recommendation strategy information sets corresponding to a collection of content will be displayed in the presentation area 502.

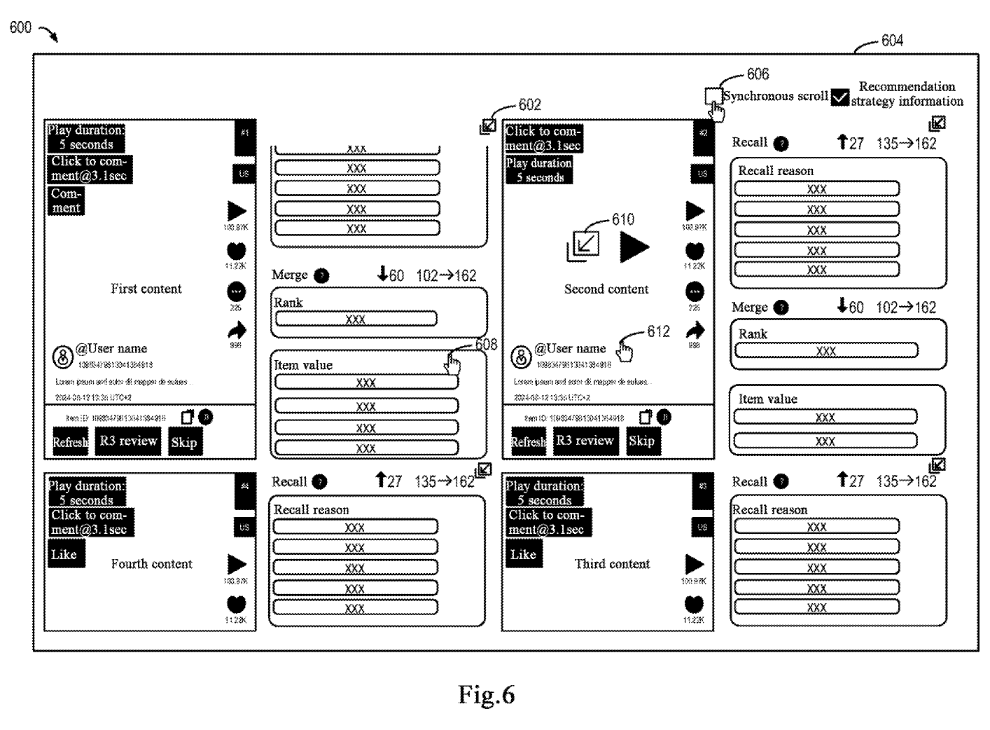

The schematic diagram of the example of the tile arrangement for viewing interface content in accordance with some embodiments of the present disclosure has been described above with reference to FIG. 5. Next, a schematic diagram of an example of displaying the recommendation strategy information set for viewing interface content in accordance with some embodiments of the present disclosure is to be depicted in conjunction with FIG. 6.

In the example 600 of FIG. 5, with reference to the previous example 500, when the recommendation strategy information control is selected, a collection of recommendation strategy information sets corresponding to a collection of content will be displayed in the presentation area 604.

At this point, the cursor 608 may swipe in the second display area where a collection of recommendation strategy information sets corresponding to a collection of content are positioned, to display the content in the recommendation strategy information sets in a scrolling manner.

In some embodiments, when the cursor hovers over a third display area corresponding to the second content, an extension control 610 appears and the extension control 610 may receive an operation for it to return to the vertical arrangement display mode. In addition, the control 602 also may receive an operation for it to return to the vertical arrangement display mode.

The user interface also includes a synchronous scroll control 606. Additionally, when the recommendation strategy information is selected and the related content is displayed, the synchronous scroll control 606 appears in the user interface.

After the synchronous scroll control 606 is selected, content in all recommendation strategy information sets may be scrolled synchronously.

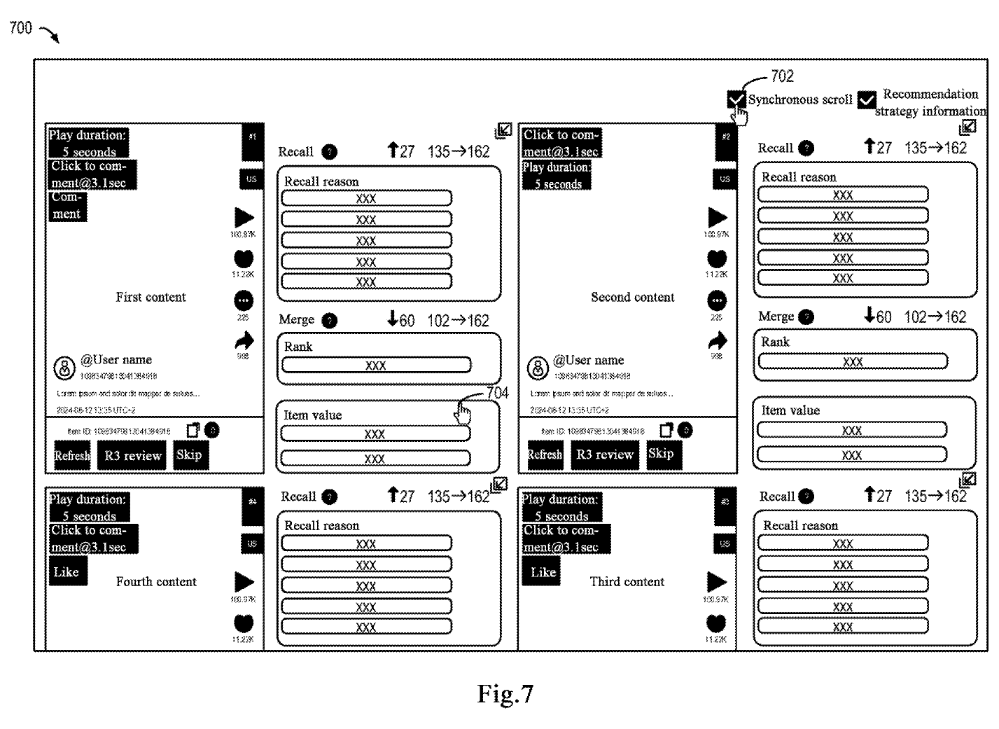

The schematic diagram of the example of displaying the recommendation strategy information set for viewing interface content in accordance with some embodiments of the present disclosure has been described above with reference to FIG. 6. Next, a schematic diagram of an example of synchronous scroll for viewing interface content in accordance with some embodiments of the present disclosure is to be depicted in conjunction with FIG. 7.

In the example 700 of FIG. 7, with reference to the previous example 600, when the synchronous scroll control 702 is selected by an operation, a swiping operation is performed via the cursor 704 in the target recommendation information set to synchronously scroll the content in other strategy information sets.

Additionally, when the synchronous scroll control 702 is selected, the content in the collection of recommendation strategy information sets are synchronously scrolled to the same position.

In some embodiments, if the extension control is operated at this point, the display mode is returned to the vertical arrangement. Moreover, after the display mode is returned to the vertical arrangement, the last display state under the previous vertical arrangement display mode is displayed.

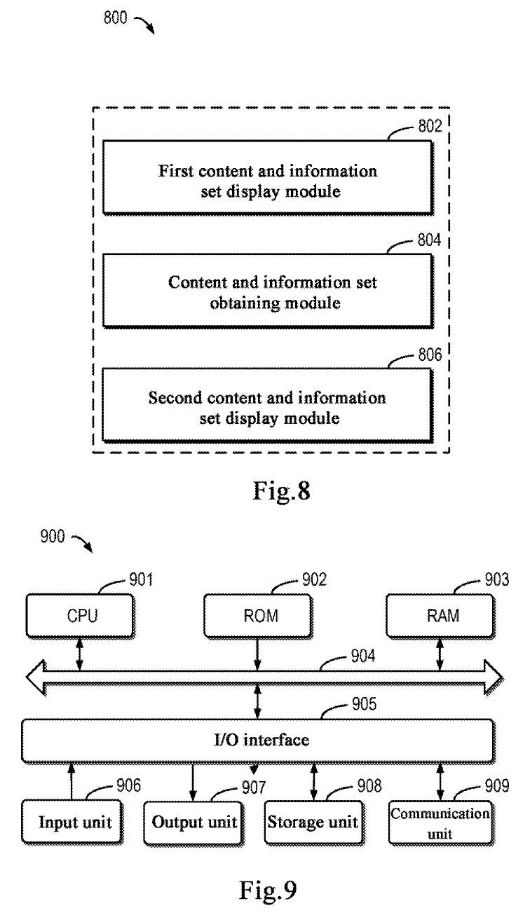

FIG. 8 illustrates a schematic block diagram of an apparatus for viewing interface content in accordance with some embodiments of the present disclosure is to be depicted in conjunction with FIG. 11. As shown in FIG. 8, the apparatus 800 includes first content and information set display module 802, configured to display first content and a first recommendation strategy information set for recommending the first content on a user interface; a content and information set obtaining module 804, configured to, in response to receiving, in a display area of the first content, a swiping operation for the first content, obtain second content and a second recommendation strategy information set for recommending the second content; and a second content and information set display module 806, configured to, in response to the swiping operation being completed, display the second content and the second recommendation strategy information set on the user interface.

In some embodiments, the first content and information set display module 802 includes: a first content determination module, configured to determine the first content to be displayed; a module for obtaining recommendation strategy information, configured to obtain recommendation strategy information related to a plurality of recommendation phases of the first content; a module for generating first recommendation strategy information set, configured to generate, based on the recommendation strategy information related to the plurality of recommendation phases, the first recommendation strategy information set; and a module for displaying first content and first recommendation strategy information set, configured to display the first content and the first recommendation strategy information set.

In some embodiments, the module for displaying first content and first recommendation strategy information set includes: a module for displaying a plurality of recommendation phases, configured to display the plurality of recommendation phases of the first content; and a module for displaying recommendation strategy information configured to display recommendation strategy information corresponding to at least one recommendation phase of the plurality of recommendation phases.

In some embodiments, wherein the first content and the first recommendation strategy information set are displayed in a vertical arrangement layout in the user interface, the user interface includes a tile arrangement control, and the apparatus 800 further includes: a module for obtaining a plurality of content, configured to, in response to the tile arrangement control being selected, obtain a plurality of pieces of content including the first content; and a module for displaying a plurality of pieces of content, configured to display the plurality of pieces of content in a tile arrangement in the user interface.

In some embodiments, wherein the user interface includes a recommendation strategy information display control, and the apparatus 800 further includes: a module for selecting a collection of content, configured to, in response to receiving a selection for the recommendation strategy information display control, select a collection of content from the plurality of pieces of content; a module for obtaining recommendation strategy information set, configured to obtain a recommendation strategy information set corresponding to each content in the collection of content; and a module for displaying a collection of content and a corresponding collection of recommendation strategy information sets, configured to display each content in the collection of content and the corresponding recommendation strategy information set in the user interface.

In some embodiments, the display area is a first display area, and the swiping operation is a first swiping operation, and the apparatus 800 also includes: a first cursor moving module, configured to move a cursor to a second display area, the second display area being used for displaying a target recommendation strategy information set corresponding to target content in the collection of content; and a module for displaying, in a scrolling manner, content of target recommendation strategy information set, configured to, in response to receiving, in the second display area, a second swiping operation for the target recommendation strategy information set, display, in a scrolling manner, content of the target recommendation strategy information set.

In some embodiments, wherein the user interface also includes a synchronous scroll control, and the apparatus 800 also includes: a selection receiving module, configured to receive a selection on the synchronous scroll control; and a module for displaying, in a scrolling manner, content in a collection of recommendation strategy information set, configured to, in response to receiving, in the second display area, a third swiping operation for the target recommendation strategy information set, display, in a scrolling manner, content of a recommendation strategy information set corresponding to each content in the collection of content.

In some embodiments, the apparatus 800 also includes: a second cursor moving module, configured to, in response to the cursor moving to a third display area for the target content, display an extension control in the third display area; and a module for displaying vertical arrangement layout, configured to, in response to receiving an operation for the extension control, display the target content and the target recommendation strategy information set in a vertical arrangement layout in the user interface.

In some embodiments, swiping operation is implemented by a mouse wheel or a touchpad.

In some embodiments, the apparatus 800 also includes: a module for visually emphasizing first content, configured to, in response to a cursor hovering in the display area of the first content, visually emphasize the first content.

In some embodiments, the module for visually emphasizing first content includes: a highlighting module or a bolding module, configured to, in response to the cursor hovering in the display area of the first content, display an edge of the display area in highlight or bold.

FIG. 9 illustrates a schematic block diagram of an example device 900 for implementing embodiments of the present disclosure. The computing device 102 in FIG. 1 may be implemented by the device 900. As shown in FIG. 9, the device 900 includes a central process unit (CPU) 901, which can execute various suitable actions and processing based on the computer program instructions stored in the read-only memory (ROM) 902 or computer program instructions loaded in the random-access memory (RAM) 903 from the storage unit 908. The RAM 903 can also store all kinds of programs and data required by the operation of the device 900. CPU 901, ROM 902 and RAM 903 are connected to each other via a bus 904. The input/output (I/O) interface 905 is also connected to the bus 904.

A plurality of components in the device 900 is connected to the I/O interface 905, including: an input unit 906, such as keyboard, mouse and the like; an output unit 908, e.g., various kinds of display and loudspeakers etc.; a storage unit 908, such as disk and optical disk etc.; and a communication unit 909, such as network card, modem, wireless transceiver and the like. The communication unit 909 allows the device 900 to exchange information/data with other devices via the computer network, such as Internet, and/or various telecommunication networks.

The above described procedure and processing, such as method 200 and examples 300-700, can be executed by the processing unit 901. For example, in some embodiments, method 200 and examples 300-700 can be implemented as a computer software program tangibly included in the machine-readable medium, e.g., storage unit 908. In some embodiments, the computer program can be partially or fully loaded and/or mounted to the apparatus 900 via ROM 902 and/or communication unit 909. When the computer program is loaded to RAM 903 and executed by the CPU 901, one or more actions of the above described example method 200 and examples 300-700.

The present disclosure can be method, apparatus, system and/or computer program product. The computer program product can include a computer-readable storage medium, on which the computer-readable program instructions for executing various aspects of the present disclosure are loaded.

The computer-readable storage medium can be a tangible apparatus that maintains and stores instructions utilized by the instruction executing apparatuses. The computer-readable storage medium can be, but not limited to, such as electrical storage device, magnetic storage device, optical storage device, electromagnetic storage device, semiconductor storage device or any appropriate combinations of the above. More concrete examples of the computer-readable storage medium (non-exhaustive list) include: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instruction can be downloaded from the computer-readable storage medium to each computing/processing device, or to an external computer or external storage via Internet, local area network, wide area network and/or wireless network. The network can comprise copper-transmitted cable, optical fiber transmission, wireless transmission, router, firewall, switch, network gate computer and/or edge server. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions of instruction set architecture (ISA), machine instructions, machine-related instructions, micro codes, firmware instructions, state setting data, or source codes or target codes written in any combinations of one or more programming languages, wherein the programming languages comprise object-oriented programming languages, e.g., Smalltalk, C++ and so on, and traditional procedural programming languages, such as “C” language or similar programming languages. The computer-readable program instructions can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider). In some embodiments, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

Various aspects of the present disclosure are described here with reference to flow chart and/or block diagram of method, apparatus (system) and computer program products according to embodiments of the present disclosure. It should be understood that each block of the flow chart and/or block diagram and the combination of various blocks in the flow chart and/or block diagram can be implemented by computer-readable program instructions.

The computer-readable program instructions can be provided to the processing unit of general-purpose computer, dedicated computer or other programmable data processing apparatuses to manufacture a machine, such that the instructions that, when executed by the processing unit of the computer or other programmable data processing apparatuses, generate an apparatus for implementing functions/actions stipulated in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions includes an article of manufacture, including instructions for implementing various aspects of the functions/actions stipulated in one or more blocks of the flow chart and/or block diagram.

The computer-readable program instructions can also be loaded into computer, other programmable data processing apparatuses or other devices, so as to execute a series of operation steps on the computer, other programmable data processing apparatuses or other devices to generate a computer-implemented procedure. Therefore, the instructions executed on the computer, other programmable data processing apparatuses or other devices implement functions/actions stipulated in one or more blocks of the flow chart and/or block diagram.

The flow chart and block diagram in the drawings illustrate system architecture, functions and operations that may be implemented by system, method and computer program product according to multiple implementations of the present disclosure. In this regard, each block in the flow chart or block diagram can represent a module, a part of program segment or code, wherein the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Various embodiments of the present disclosure have been described above and the above description is only exemplary rather than exhaustive and is not limited to the embodiments of the present disclosure. Many modifications and alterations, without deviating from the scope and spirit of the explained various embodiments, are obvious for those skilled in the art. The selection for terms in the text aims to best explain principles and actual applications of each embodiment and technical improvements made in the market by each embodiment, or enable those ordinary skilled in the art to understand embodiments of the present disclosure.

I/We claim:

1. A method for viewing interface content, comprising:
displaying first content and a first recommendation strategy information set for recommending the first content on a user interface;
in response to receiving, in a display area of the first content, a swiping operation for the first content, obtaining second content and a second recommendation strategy information set for recommending the second content; and
in response to the swiping operation being completed, displaying the second content and the second recommendation strategy information set on the user interface.

2. The method of claim 1, wherein displaying the first content and the first recommendation strategy information set for recommending the first content on the user interface comprises:
determining the first content to be displayed;
obtaining recommendation strategy information related to a plurality of recommendation phases of the first content;
generating, based on the recommendation strategy information related to the plurality of recommendation phases, the first recommendation strategy information set; and
displaying the first content and the first recommendation strategy information set.

3. The method of claim 2, wherein displaying the first content and the first recommendation strategy information set comprises:
displaying the plurality of recommendation phases of the first content; and
displaying recommendation strategy information corresponding to at least one recommendation phase of the plurality of recommendation phases.

4. The method of claim 1, wherein the first content and the first recommendation strategy information set are displayed in a vertical arrangement layout in the user interface, the user interface comprises a tile arrangement control, and the method further comprises:
in response to the tile arrangement control being selected, obtaining a plurality of pieces of content comprising the first content; and
displaying the plurality of pieces of content in a tile arrangement in the user interface.

5. The method of claim 4, wherein the user interface comprises a recommendation strategy information display control, and the method further comprises:
in response to receiving a selection for the recommendation strategy information display control, selecting a collection of content from the plurality of pieces of content;
obtaining a recommendation strategy information set corresponding to each content in the collection of content; and
displaying each content in the collection of content and the corresponding recommendation strategy information set in the user interface.

6. The method of claim 5, wherein the display area is a first display area, the swiping operation is a first swiping operation, and the method further comprises:
moving a cursor to a second display area, the second display area being used for displaying a target recommendation strategy information set corresponding to target content in the collection of content; and
in response to receiving, in the second display area, a second swiping operation for the target recommendation strategy information set, displaying, in a scrolling manner, content of the target recommendation strategy information set.

7. The method of claim 6, wherein the user interface further comprises a synchronous scroll control, and the method further comprises:
receiving a selection on the synchronous scroll control; and
in response to receiving, in the second display area, a third swiping operation for the target recommendation strategy information set, synchronously displaying, in a scrolling manner, content of a recommendation strategy information set corresponding to each content in the collection of content.

8. The method of claim 7, further comprising:
in response to the cursor moving to a third display area for the target content, displaying an extension control in the third display area; and
in response to receiving an operation for the extension control, displaying the target content and the target recommendation strategy information set in a vertical arrangement layout in the user interface.

9. The method of claim 1, wherein the swiping operation is implemented by a mouse wheel or a touchpad.

10. The method of claim 1, further comprising:
in response to a cursor hovering in the display area of the first content, visually emphasizing the first content.

11. The method of claim 10, wherein visually emphasizing the first content comprises:
in response to the cursor hovering in the display area of the first content, displaying an edge of the display area in highlight or bold.

12. An electronic device, comprising:
at least one processor; and
a storage apparatus, configured to store at least one program, wherein the at least one program, when executed by the at least one processor, causes the at least processor to:
display first content and a first recommendation strategy information set for recommending the first content on a user interface;
in response to receiving, in a display area of the first content, a swiping operation for the first content, obtain second content and a second recommendation strategy information set for recommending the second content; and
in response to the swiping operation being completed, display the second content and the second recommendation strategy information set on the user interface.

13. The electronic device of claim 12, wherein the at least one program causing the at least processor to display the first content and the first recommendation strategy information set for recommending the first content on the user interface further causes the at least processor to:
determine the first content to be displayed;
obtain recommendation strategy information related to a plurality of recommendation phases of the first content;
generate, based on the recommendation strategy information related to the plurality of recommendation phases, the first recommendation strategy information set; and
display the first content and the first recommendation strategy information set.

14. The electronic device of claim 13, wherein the at least one program causing the at least processor to display the first content and the first recommendation strategy information set further causes the at least processor to:
display the plurality of recommendation phases of the first content; and
display recommendation strategy information corresponding to at least one recommendation phase of the plurality of recommendation phases.

15. The electronic device of claim 12, wherein the first content and the first recommendation strategy information set are displayed in a vertical arrangement layout in the user interface, the user interface comprises a tile arrangement control, and the at least one program further causes the at least processor to:
in response to the tile arrangement control being selected, obtain a plurality of pieces of content comprising the first content; and
display the plurality of pieces of content in a tile arrangement in the user interface.

16. The electronic device of claim 15, wherein the user interface comprises a recommendation strategy information display control, and the at least one program further causes the at least processor to:
in response to receiving a selection for the recommendation strategy information display control, select a collection of content from the plurality of pieces of content;
obtain a recommendation strategy information set corresponding to each content in the collection of content; and
display each content in the collection of content and the corresponding recommendation strategy information set in the user interface.

17. The electronic device of claim 16, wherein the display area is a first display area, the swiping operation is a first swiping operation, and the at least one program further causes the at least processor to:
move a cursor to a second display area, the second display area being used for displaying a target recommendation strategy information set corresponding to target content in the collection of content; and
in response to receiving, in the second display area, a second swiping operation for the target recommendation strategy information set, display, in a scrolling manner, content of the target recommendation strategy information set.

18. The electronic device of claim 17, wherein the user interface further comprises a synchronous scroll control, and the at least one program further causes the at least processor to:
receive a selection on the synchronous scroll control; and
in response to receiving, in the second display area, a third swiping operation for the target recommendation strategy information set, synchronously display, in a scrolling manner, content of a recommendation strategy information set corresponding to each content in the collection of content.

19. The electronic device of claim 18, wherein the at least one program further causes the at least processor to:
in response to the cursor moving to a third display area for the target content, display an extension control in the third display area; and
in response to receiving an operation for the extension control, display the target content and the target recommendation strategy information set in a vertical arrangement layout in the user interface.

20. A non-transitory computer-readable storage medium storing a computer program thereon, wherein the computer program, when executed by a processor, causes the processor to:
display first content and a first recommendation strategy information set for recommending the first content on a user interface;
in response to receiving, in a display area of the first content, a swiping operation for the first content, obtain second content and a second recommendation strategy information set for recommending the second content; and
in response to the swiping operation being completed, display the second content and the second recommendation strategy information set on the user interface.
